(19) United States
(12) Patent Application Publication
(10) Pub. No.: US 2024/0293927 A1
(43) Pub. Date: Sep. 5, 2024

(54) HOT STICK PROTECTION ASSEMBLY

(71) Applicants: Zachary Scott Brouhard, Hooker, OK (US); Kyle Weber, Liberal, KS (US)

(72) Inventors: Zachary Scott Brouhard, Hooker, OK (US); Kyle Weber, Liberal, KS (US)

(21) Appl. No.: 18/116,035

(22) Filed: Mar. 1, 2023

(51) Int. Cl. B25H 3/00; B25B 9/00

(52) U.S. Cl. CPC B25H 3/00; B25B 9/00

(57) ABSTRACT

A hot stick protection assembly for protection of upper and lower ends of an electrician's hot stick when being stowed or transported, the protection assembly, including a first protection guard having a generally ring-shaped configuration that includes an inner surface that defines a central bore for selectively mating with the upper end of the hot stick. I the first protection guard includes an outer surface opposite the inner surface. The first protection guard includes a holder portion extending laterally away from the outer surface and that defines an inset channel having an upstanding configuration. Further, the hot stick protection assembly includes a second protection guard comprising a tube cap defining an open top and configured to selectively engage a lower end of the electrician's hot stick in a friction fit attachment.

### BACKGROUND OF THE INVENTION

This invention relates generally to storage sleeve guards and, more particularly, to a pair of hot stick protection assembly that includes a pair of storage guards for protecting opposed ends of an electrician's hot stick during storage or transport. Further, the present invention includes a storage guard defining a recess configured to engage a hot stick head of a type that folds downwardly from an upper end of the hot stick.

In the electric power distribution sector, a hot stick is an insulated pole commonly used by electric utility workers, i.e., linemen, when working on energized high-voltage electric power lines. Various heads of work tools may be coupled to an upper end of a hot stick such that an electrical worker may test it for voltage, tighten nuts and bolts, apply high wires (twisted lengths of ductile wire which fasten the running cable to its supporting insulators), open and close switches, replace fuses, place insulating sleeves on wires, and perform various other tasks-all while protecting workers from a large risk of electrical shock. Further, a hot stick may be an adjustable or telescopic rod that enables the aforementioned tasks to be conducted from a distance, whether from 3 to 30 feet away in some instances. Hot stick poles are often made of fiberglass because it is a very weak conductor of electricity and, therefore, provides electrical insulation to protect workers. The distance of workers is also important to protect them against possible electrical arcs emanating from actual electric equipment or machinery that is being worked on.

There are many different types of heads or tools that may be coupled to an upper end of the hot stick, i.e., to the insulated rod. For instance, a common tool includes a hook member having a configuration that enables a live wire to be disengaged or a switch to be opened or closed—in either case, a hook tool or the like is used to modify or disengage an electrical circuit and to deactivate or deenergize a previously “live” electrical line so that it becomes safe for workers to touch. Although various hot stick tools have very unique configurations that are associated with or complementary to particular electrical equipment, a common tool extends downwardly and parallel to a longitudinal axis defined by the hot stick itself or relative to the sleeve in which a hot stick may be stored. It should be appreciated that the bent or folded tool may not work with a traditional storage guard or cap.

As discussed above, hot sticks are often constructed from fiberglass for safety purposes as fiberglass is not a good conductor of electricity. Unfortunately, fiberglass is a fragile or brittle material that is easily and commonly chipped, damaged, or otherwise fragmented. More particularly, electric industry linemen often store their hot sticks, respectively, in the bed of a bucket truck, pickup truck, or other relatively hard surface that may cause damage to the fiberglass construction of a hot stick and, especially, to the upper end to which a tool may be attached. In some instances, each hot stick may be stored in a protective sleeve. Although a protective sleeve is advantageous to prevent damage to opposite ends or to the head/tool operatively coupled to the upper end of a hot stick, it is still common for a hot stick to be damaged, namely, because the ends of the sleeve are open. In fact, the protective sleeve often allows the hot stick to inadvertently slide out or roll around in the sleeve and become damaged.

Therefore, it would be desirable to have a protection assembly that includes a pair of hot stick storage guards that may be coupled to opposed ends of a hot stick, respectively, that protect opposed ends of the hot stick from damage during storage. Further, it would be desirable to have a protection assembly that includes a pair of hot stick storage guards having a configuration operative to receive and even engage a portion of a disconnect head of a hot stick.

### SUMMARY OF THE INVENTION

A hot stick protection assembly according to the present invention includes a first storage guard having a body member that has a ring-shaped configuration defining a central bore for receiving an an upper end of an electrician's hot stick in a friction fit engagement. An outer wall of the body member defines a recessed channel that defines a longitudinal axis that is parallel to a longitudinal axis defined by the central bore, said recessed channel being configured to receive a portion of a tool coupled to the upper end of the hot stick. The protection assembly includes a second storage guard having a cap-shaped body member defining an open end and interior space configured to receive and mate with a lower end of the electrician's hot stick. Both body members have a diameter that is larger than a diameter of the hot stick.

Therefore, a general object of this invention is to provide a hot stick protection assembly having a pair of storage guards attached to opposed ends of an electrician hot stick, respectively, and that are configured to protect the hot stick against damage as a result of contact between a respective hot stick and protective sleeve.

Another object of this invention is to provide a hot stick protection assembly hot stick, as aforesaid, in which at least one storage guard includes an outer wall defining a depression or channel capable of receiving a portion of a hot stick tool.

Still another object of this invention is to provide a hot stick protection assembly as aforesaid, in which each safety guard defines a diameter that is larger than an inner diameter defined by a storage sleeve.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a hot stick protection assembly according to a preferred embodiment of the present invention, illustrated coupled to an electrician's hot stick;

FIG. 2 is a perspective view of the hot stick protection assembly as in FIG. 1, illustrated coupled to a hot stick in a lengthened configuration;

FIG. 3 is an exploded view of hot stick protection assembly as in FIG. 2;

FIG. 4 is a perspective view of a hot stick protection assembly, illustrated with a hot stick positioned within a protective sleeve according to an embodiment of the present invention;

FIG. 5 is a perspective view from an upper angle of the hot stick protection assembly shown in FIG. 4;

FIG. 6 is a perspective view of the stick protection assembly as in FIG. 4, illustrated with an upper end closed by and endcap fastener;

FIG. 7 is a perspective view of the stick protection assembly as in FIG. 6, illustrated using phantom lines to show the hot stick positioned inside the protective sleeve; and

FIG. 8 is a perspective view of the stick protection assembly illustrating the first and second protective guards removed from the hot stick according to the present invention.

### DESCRIPTION OF THE PREFERRED EMBODIMENT

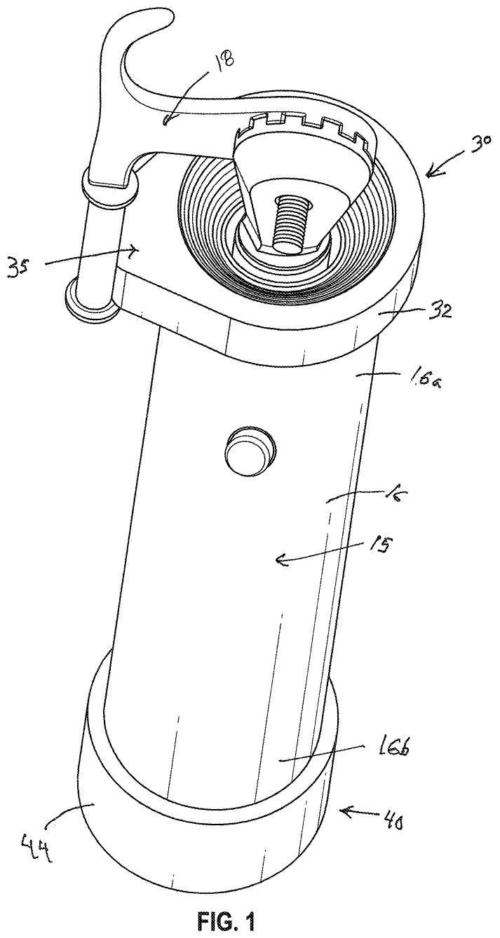

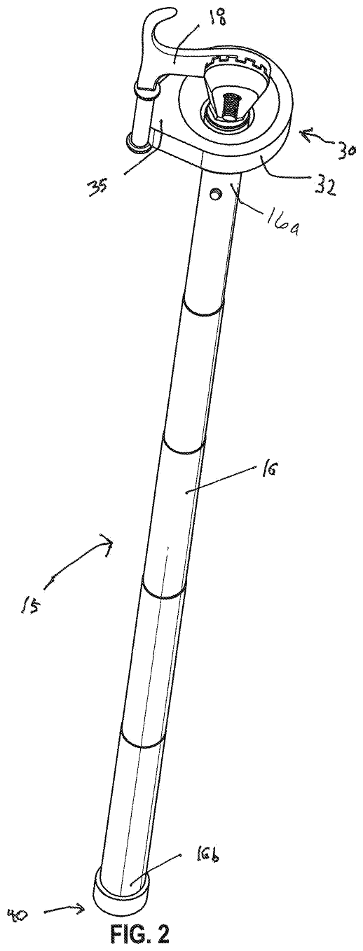

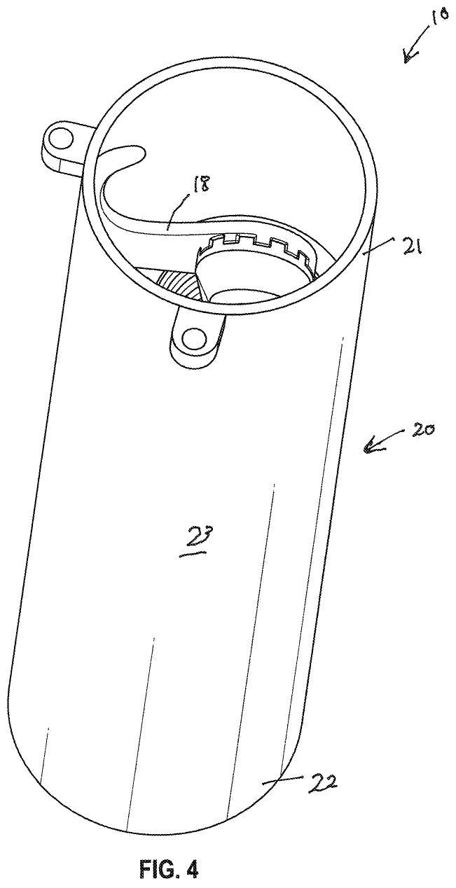

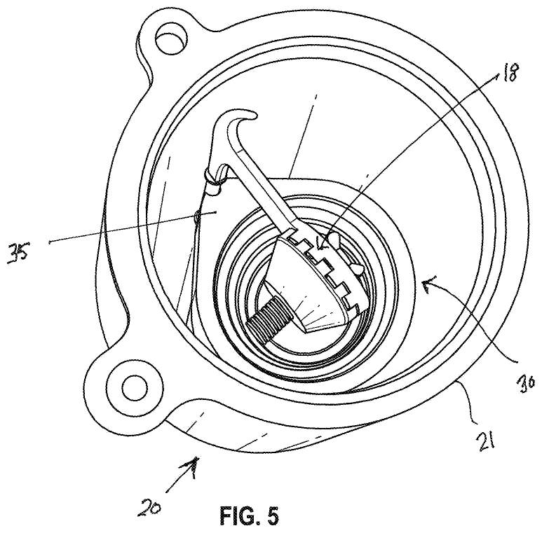

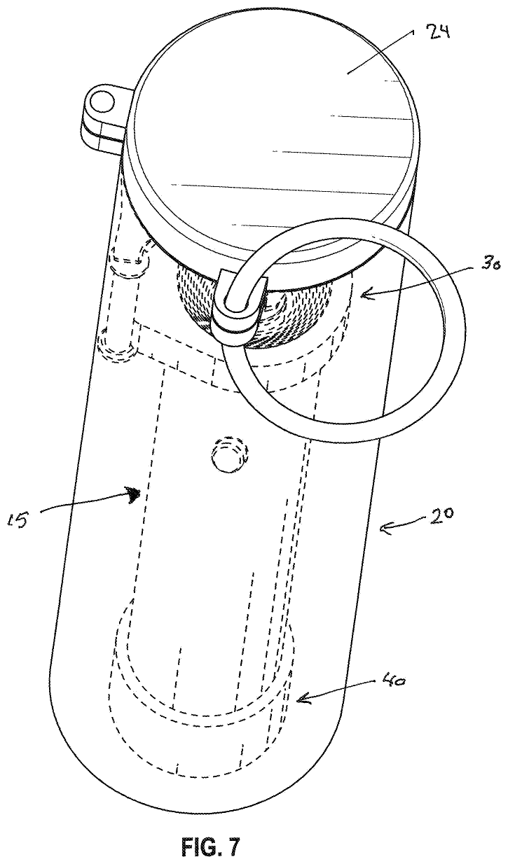

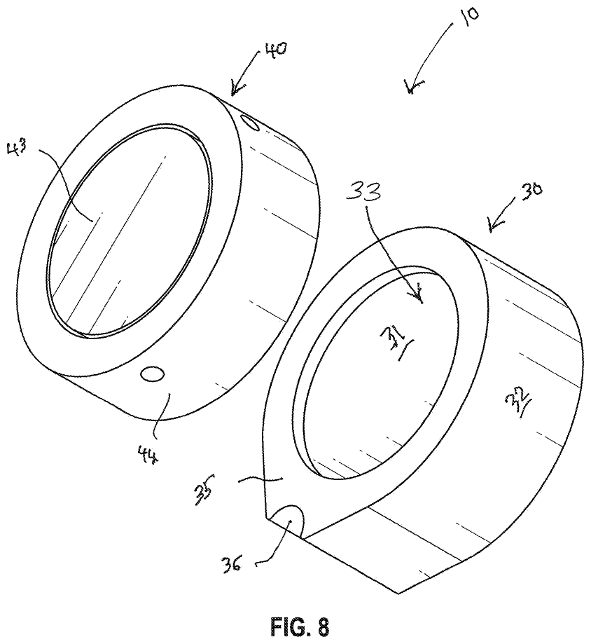

A hot stick protection assembly according to a preferred embodiment of the present invention will now be described with reference to FIGS. 1-8 of the accompanying drawings. The hot stick protection assembly 10 includes a first protection guard 30 and a second protection guard 40, both of which are configured to protect ends of an electrician's hot stick 15, especially when the hot stick 15 is stored or transported in a storage sleeve 20.

The hot stick 15 that is protected by the hot stick protection assembly 10 is an elongate rod that is routinely used by an electrical lineman (also referred to as an electrician's hot stick) to do electrical work on electrical lines or electrical machinery from a distance so as to minimize any opportunity that the electrical lineman come into contact with live sources of electricity which may, unfortunately, be fatal. For context, the hot stick 15 includes a body portion 16 having an elongate and linear configuration extending between a lower end 16b and an upper end 16a. In some embodiments, the body portion 16 may have a fixed and predetermined length whereas in other embodiments, the body portion 16 may have a length adjustable configuration that enables a lineman to access electrical components from a substantial distance while still enabling the hot stick 15 to be stored or transported, such as in an electrical truck, standard pickup truck, safety sleeve, or the like. In other words, the body portion 16 may have a telescopic construction, such as using slidable segments that may be fixed with pins, spring-loaded tabs, or the like. For the sake of clarification, the body portion 16 of a hot stick 15 defines an imaginary linear axis. In some embodiments, the hot stick 15 may include a tool 18 attached to the upper end 16a and that is configured to engage an electric wire, gate, switch, bolt, or other electrical components. Some tools extend upwardly, laterally, or both laterally and downwardly alongside the hot stick 15. In a critical aspect, the first protection guard 30 is configured to receive a portion of the tool 18 so as to prevent rotational movement of the hot stick 15 during storage or transport as will be described in detail later.

It is understood that a traditional hot stick 15 is constructed of fiberglass or similar material that is delicate, fragile, and that is easily chipped, broken, cracked, or otherwise damaged, especially when stored or transported. Accordingly, the hot stick protection assembly 10 may include a pair of protection guards particularly configured for attachment to the opposed ends of a hot stick 15 so as to protect the opposed ends from damage that may be caused by rolling around inside the bed of a truck or even within the interior space of a protective sleeve 20.

More particularly, the hot stick protection assembly 10 may include a first protection guard 30 that is configured for selective and removable attachment to the upper end 16a of the hot stick 15. Even more specifically, the first protection guard 30 includes a generally annular configuration, i.e., the first protection guard 30 has a ring-shaped configuration having an inner surface 31 and an outer surface 32, the inner surface 31 defining a void that will be referred to as a central bore 33. As shown, the central bore 33 is configured to receive the upper end 16a of the hot stick 15 in a friction fit and nested configuration. In a preferred embodiment, the first protection guard 30 may simply be press-fit onto the upper end 16a without the use of any fasteners. However, in an embodiment (not shown), the first protection guard 30 may include a pin, screw, or other fastener for tightening the inner surface 31 around the hot stick 15.

Further and as introduced previously, the first protection guard 30 may include a toolholder portion 35 extending outwardly from one side of the outer surface 32. The toolholder portion 35 may have the appearance of a supplementary thickness to the outer surface 32 or referred to as an offset to the outer surface 32 (FIGS. 1-3). Of critical importance, the toolholder portion 35 defines an upstanding inset channel 36. The inset channel 36 extends between a bottom wall 36a and top wall 36b of the first protection guard 30 and is parallel to the imaginary axis defined by the central bore 33 defined by the inner surface 31. Preferably, the inset channel 36 is inwardly concave or recessed and has a curvature so as to receive a portion of a tool 18 so as to inhibit or prevent rotation thereof (FIGS. 1-3).

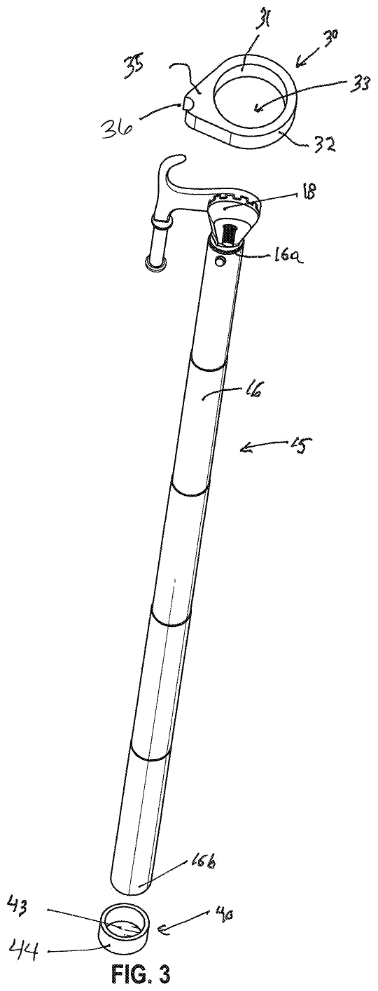

The hot stick protection assembly includes a second protection guard 40. More particularly, the second protection guard 40 may include what appears as a tube cap having a bottom wall 43 with a continuous sidewall 44 extending upwardly from a peripheral edge of the bottom wall 43, the continuous sidewall 44 having a free edge 45 defining an open top. The bottom wall 43 and sidewall 44, together, define an interior area complementary to and capable of receiving the lower end 16b of the hot stick 15 (FIG. 3).

Preferably, the first protection guard 30 and second protection guard 40 include critical diameters that are complementary to those of the hot stick 15 so as to be frictionally coupled to the hot stick 15. More particularly, the inner surface 31 of the first protection guard 30 defines a first predetermined diameter. Similarly, the continuous and upstanding sidewall 44 of the second protection guard 40 may define a second predetermined diameter. Preferably, the first and second predetermined diameters associated with the first and second protection guards, respectively, are complementary to the outer diameters defined by the upper and lower ends of a hot stick 15, respectively. Namely, the first and second protection guards 30, 40 may be quickly and slidably pressed onto opposed ends of a hot stick 15 without tools. Similarly, the inset channel 36 is configured to quickly receive a portion of a tool 18 in a press-fit/friction-fit/snap-fit configuration.

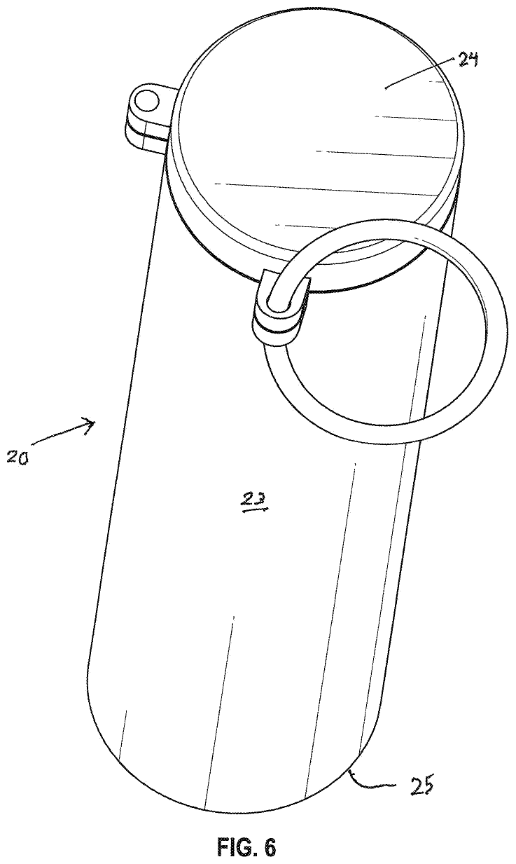

In an embodiment, the hot stick protection assembly 10 further includes a storage sleeve 20. More particularly, the storage sleeve 20 includes a continuous sidewall 23 having a tubular and elongate configuration that defines an interior space. The storage sleeve 20 includes a proximal end 21 and a distal end 22 that is oppositely disposed from the proximal end 21. Both ends of the protective sleeve 20 are open and, therefore, in communication with the interior space. Preferably, the continuous sidewall 23 defines a diameter that is larger than a diameter of the hot stick 15 and includes a length that is longer than a length of the hot stick 15 such that the hot stick 15 may be slidably inserted into the sleeve via its open proximal end 21. In addition, the storage sleeve 20 may include a pair of fasteners that, when deployed, will close or block each open end. Specifically, the storage sleeve 20 may include a first cap 24 and a second cap 25 removably coupled to the proximal and 21 and distal ends 22, respectively. It is understood that, in an embodiment, the second cap 18 refers simply to a closed bottom end (FIG. 6). The first cap 24 and second cap 25 may include fasteners for releasably coupling respective caps to the open ends of the continuous sidewall 23, such as pins, snaps, latches, hinges, hook and loop patches, or the like.

In use, it is intended that the hot stick protection assembly 10 is utilized immediately prior to positioning an electrician's hot stick 15 onto the electrician's truck or into a storage sleeve 20 for storage or transport. Specifically, it is intended that the first protection guard 30 be releasably coupled, such as in a nesting or press-fit arrangement, to the upper end 16a of the hot stick 15 and the second protection guard 40 be releasably coupled to the lower end 16b of the hot stick 15 as described above. It is understood that each protection guard (30, 40) has a diameter greater than a diameter of the body portion of the hot stick 15 such that the protection guards alone will make contact with an inner surface of the sleeve 20. Accordingly, the upper end 16a and lower end 16b of the hot stick 15 will never make independent contact with the inner surface of the protective sleeve 20 (when inserted therein) and cannot be damaged thereby.

It is understood that while certain forms of this invention have been illustrated and described, it is not limited thereto except insofar as such limitations are included in the following claims and allowable functional equivalents thereof.

1. A hot stick protection assembly for protection of opposed ends of an electrician's hot stick when stored within a storage sleeve, said protection assembly, comprising:
a first protection guard having a generally annular configuration having an inner surface that defines a central bore for selectively mating with an upper end of the electrician's hot stick and having an outer surface generally opposite said inner surface,
said first protection guard having a tool holder portion offset from said outer surface and defining a channel having an upstanding configuration;
a second protection guard comprising a tube cap defining an open top and configured to selectively engage a lower end of the electrician's hot stick in a friction fit attachment.

2. The hot stick protection assembly as in claim 1, wherein:
the electrician's hot stick includes a body portion having an elongate and linear configuration extending between said lower end and said upper end, said body portion defining an imaginary linear axis; and
said channel of said tool holder portion defines an inwardly concave configuration that is configured to selectively receive a portion of a tool operatively coupled to said upper end of said electrician's hot stick and that defines an imaginary axis that is offset from and parallel to said imaginary linear axis defined by said electrician's hot stick.

3. The hot stick protection assembly as in claim 1, wherein:
said inner surface of said first protection guard defines a first predetermined diameter;
said second protection guard includes a continuous upstanding sidewall defining a second predetermined diameter that is substantially the same as said first predetermined diameter; and
said first and second predetermined diameters are complementary to outside diameters of said upper and said lower ends of said electrician's hot stick, respectively, such that said first protection guard and said second protection guard are selectively coupled to said upper and said lower ends of said electrician's hot stick, respectively, in a friction fit attachment.

4. The hot stick protection assembly as in claim 3, wherein said second protection guard includes a bottom wall having a generally planar configuration and said continuous upstanding sidewall extending upwardly from a peripheral edge of said bottom wall such that said bottom wall and said continuous upstanding sidewall, together, define an interior area capable of receiving the lower end of said electrician's hot stick.

5. The hot stick protection assembly as in claim 1, further comprising a storage sleeve having a continuous sidewall that defines an interior space, said storage sleeve having proximal and distal ends that are opposed to one another and each being open and in communication with the interior space such that the electrician's hot stick is selectively and slidably received into the interior space via the proximal or distal end of said storage sleeve.

6. The hot stick protection assembly as in claim 5, wherein said storage sleeve includes:
a first cap removably coupled to the proximal end of said storage sleeve so as to selectively enclose the proximal end of the storage sleeve; and
a second cap removably coupled to the distal end of said storage sleeve so as to selectively enclose said distal end of the storage sleeve.

7. A hot stick protection assembly for protection of upper and lower ends of a hot stick when stowed or transported, said protection assembly, comprising:
a first protection guard having a generally ring-shaped configuration that includes an inner surface that defines a central bore for selectively mating with the upper end of the hot stick and having an outer surface opposite said inner surface,
said first protection guard having a holder portion extending laterally away from said outer surface and that defines an inset channel having an upstanding configuration;
a second protection guard comprising a tube cap defining an open top and configured to selectively engage a lower end of the electrician's hot stick in a friction fit attachment.

8. The hot stick protection assembly as in claim 7, wherein the hot stick includes a body portion having an elongate and linear configuration extending between the lower end and the upper end, said body portion defining an imaginary linear axis.

9. The hot stick protection assembly as in claim 8, wherein said inset channel of said tool holder portion is an elongate trough configured to selectively receive a portion of a tool that depends from said upper end of said hot stick and that defines an imaginary axis that is laterally offset from and parallel to said imaginary linear axis defined by the hot stick.

10. The hot stick protection assembly as in claim 9, wherein:
said inner surface of said first protection guard defines a first predetermined diameter;
said second protection guard includes a continuous upstanding sidewall defining a second predetermined diameter that is substantially the same as said first predetermined diameter; and
said first and second predetermined diameters are complementary to outside diameters of said upper and said lower ends of the hot stick, such that said first protection guard and said second protection guard are selectively coupled to said upper and said lower ends of the hot stick, respectively, in a friction fit attachment.

11. The hot stick protection assembly as in claim 10, wherein said second protection guard includes a bottom wall having a generally planar configuration and said continuous upstanding sidewall extending upwardly from a peripheral edge of said bottom wall such that said bottom wall and said continuous upstanding sidewall, together, define an interior area capable of receiving the lower end of said electrician's hot stick.

12. The hot stick protection assembly as in claim 7, wherein said second protection guard includes a bottom wall having a generally planar configuration and said continuous upstanding sidewall extending upwardly from a peripheral edge of said bottom wall such that said bottom wall and said continuous upstanding sidewall, together, define an interior area capable of receiving the lower end of said electrician's hot stick.

13. The hot stick protection assembly as in claim 7, further comprising a storage sleeve having a continuous sidewall that defines an interior space, said storage sleeve having proximal and distal ends that are opposed to one another and each being open and in communication with the interior space such that the electrician's hot stick is selectively and slidably received into the interior space via the proximal or distal end of said storage sleeve.

14. A method for protecting against damage to an electrician's hot stick of a type having an upper end displaced from a lower end, said method comprising:
attaching a first protection guard to the upper end of the hot stick, said first protection guard including an inner surface having a ring-shaped configuration and defining a central bore configured to selectively receive the upper end of said hot stick,
said first protection guard including an outer surface opposite and concentric to the inner surface,
said first protection guard including a tool holder portion extending outwardly from the outer surface, said tool holder portion defining an inset channel capable of receiving a portion of a tool that is operatively coupled to the upper end of the hot stick.

15. The method as in claim 14, further comprising attaching a second protection guard to the lower end of the hot stick, said second protection guard including a bottom wall and a continuous sidewall extending upwardly from a peripheral edge of said bottom wall, said bottom wall and said continuous sidewall together defining an interior area configured to receive the lower end of the hot stick in a nested relationship.

16. The method as in claim 15, wherein:
the electrician's hot stick includes a body portion having an elongate and linear configuration extending between said lower end and said upper end, said body portion defining an imaginary linear axis; and
said inset channel of said tool holder portion defines an inwardly concave configuration that defines an imaginary axis that is offset from and parallel to said imaginary linear axis defined by said electrician's hot stick.

17. The method of claim 14, further comprising providing a storage sleeve having a continuous sidewall that defines an interior space, said storage sleeve having proximal and distal ends that are opposed to one another and each being open and in communication with the interior space such that the electrician's hot stick is selectively and slidably received into the interior space via the proximal or distal end of said storage sleeve.

18. The method as in claim 15, wherein:
said inner surface of said first protection guard defines a first predetermined diameter;
said second protection guard includes a continuous upstanding sidewall defining a second predetermined diameter that is substantially the same as said first predetermined diameter; and
said first and second predetermined diameters are complementary to outside diameters of said upper and said lower ends of the hot stick, such that said first protection guard and said second protection guard are selectively coupled to said upper and said lower ends of the hot stick, respectively, in a friction fit attachment.
